(19) United States
(12) Patent Application Publication
(10) Pub. No.: US 2021/0129799 A1
(43) Pub. Date: May 6, 2021

(54) Vehicle Defrosting Assembly

(71) Applicants: Tracy Hostetler, Greenleaf, ID (US); Megan Hostetler, Greenleaf, ID (US); Edgar Garcia, Greenleaf, ID (US)

(72) Inventors: Tracy Hostetler, Greenleaf, ID (US); Megan Hostetler, Greenleaf, ID (US); Edgar Garcia, Greenleaf, ID (US)

(21) Appl. No.: 16/675,373

(22) Filed: Nov. 6, 2019

(51) Int. Cl. B60S 1/54; B60R 16/023; B60R 16/033; B60S 1/02; B60H 1/00; B60H 1/14

(52) U.S. Cl. CPC B60S 1/54; B60R 16/0237; B60H 1/143; B60S 1/023; B60H 1/00814; B60R 16/033

(57) ABSTRACT

A vehicle defrosting assembly includes a blower that is positioned in a cab of a vehicle. The blower circulates air within the cab when the blower is turned on. Additionally, the blower is in fluid communication with a defrost duct of the vehicle's air conditioning system. A heater is integrated into the blower to heat the cab of the vehicle thereby inhibiting the formation of frost on the vehicle's windows. A heater battery is coupled to the vehicle and the heater battery is independent from an ignition battery of the vehicle. Each of the blower and the heater is in electrical communication with the heater battery. A solar panel is coupled to an exterior of the vehicle for charging the heater battery when the vehicle is not running.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to defrosting devices and more particularly pertains to a new defrosting device for warming an interior of a vehicle when the vehicle is not running.

### (2) Description of Related Art Including Information Disclosed Under 37 CFR 1.97 and 1.98

The prior art relates to defrosting devices. The prior art discloses a secondary heating system of an over the road vehicle for heating and cooling a sleeping cab of the over the road vehicle when the over the road vehicle is parked. The prior art also discloses a thermal control device that is mounted to a door of a vehicle for warming the cab of the vehicle when the vehicle is parked. The prior art discloses a secondary heating system of a vehicle that has a remote control. Each disclosure of the prior art involves a blower that is fluidly discrete from the vehicle's existing air conditioning system.

### BRIEF SUMMARY OF THE INVENTION

An embodiment of the disclosure meets the needs presented above by generally comprising a blower that is positioned in a cab of a vehicle. The blower circulates air within the cab when the blower is turned on. Additionally, the blower is in fluid communication with a defrost duct of the vehicle's air conditioning system. A heater is integrated into the blower to heat the cab of the vehicle thereby inhibiting the formation of frost on the vehicle's windows. A heater battery is coupled to the vehicle and the heater battery is independent from an ignition battery of the vehicle. Each of the blower and the heater is in electrical communication with the heater battery. A solar panel is coupled to an exterior of the vehicle for charging the heater battery when the vehicle is not running.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic view of a vehicle defrosting assembly according to an embodiment of the disclosure.

FIG. 2 is a phantom view of an embodiment of the disclosure.

### DETAILED DESCRIPTION OF THE INVENTION

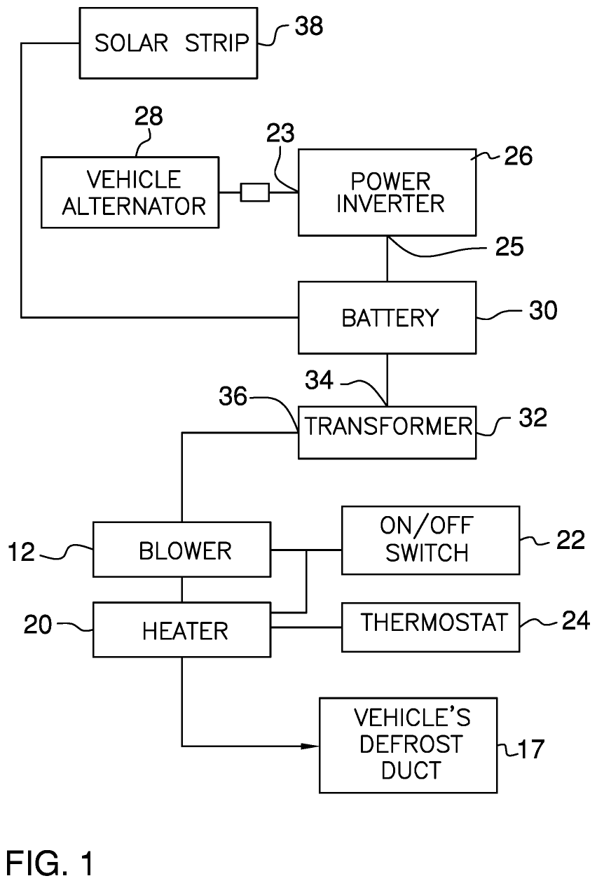

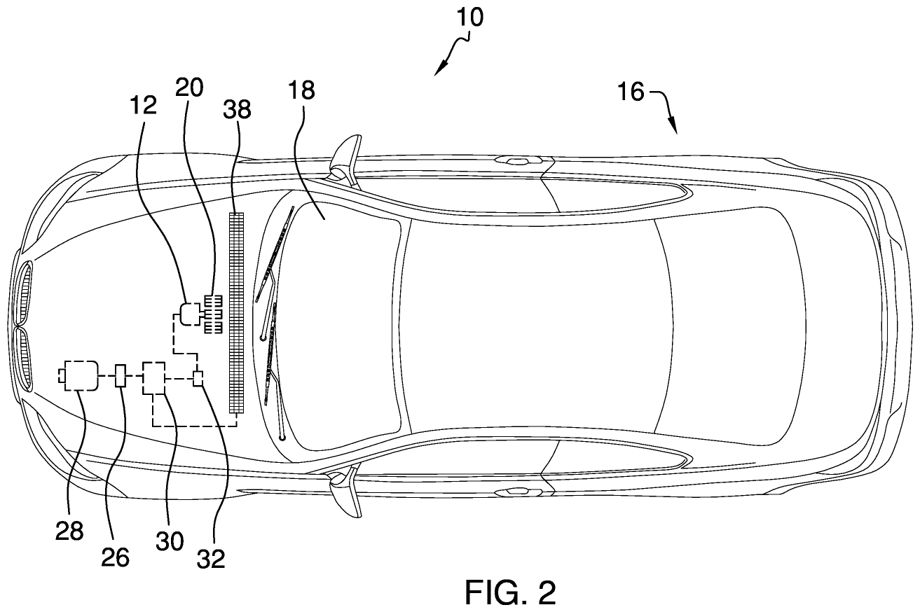

With reference now to the drawings, and in particular to FIGS. 1 through 2 thereof, a new defrosting device embodying the principles and concepts of an embodiment of the disclosure and generally designated by the reference numeral 10 will be described.

As best illustrated in FIGS. 1 through 2, the vehicle defrosting assembly 10 generally comprises a blower 12 that is positioned in a vehicle 16. The blower 12 circulates air within the vehicle 16 when the blower 12 is turned on. Additionally, the blower 12 is in fluid communication with a defrost duct 17 of the vehicle's air conditioning system. In this way the blower 12 can blow air onto a windshield 18 of the vehicle 16 when the blower 12 is turned on. The blower 12 may include an electric motor and a fan that is rotatably coupled to the motor that rotates when the motor is turned on. The blower 12 is independent from the blower of the existing air conditioning system of the vehicle 16.

A heater 20 is integrated into the blower 12 and the heater 20 is in thermal communication with the blower 12. The heater 20 heats the air circulated by the blower 12 when the heater 20 is turned on. In this way the heater 20 can heat a cab 14 of the vehicle 16 thereby inhibiting the formation of frost on the vehicle's windows. The heater 20 may comprise an electric heating coil that has an operational temperature ranging between approximately 80.0° F. and 100.0° F. A power button 22 is positioned in the cab 14 of the vehicle 16. The power button 22 is electrically coupled to the blower 12 and the heater 20. The power button 22 turns each of the blower 12 and the heater 20 on and off.

A thermostat 24 is positioned in the cab 14 of the vehicle 16 to detect the temperature in the cab 14. The thermostat 24 is electrically coupled to the heater 20. Moreover, the thermostat 24 turns off the heater 20 when the thermostat 24 detects a temperature that exceeds a pre-determined trigger temperature. The thermostat 24 may comprise an electronic thermostat or the like and the pre-determined trigger temperature may be a temperature of approximately 80.0° F. Additionally, the thermostat 24 turns the heater 20 back on again when the thermostat 24 detects a temperature that is below a pre-determined threshold temperature. The pre-determined threshold temperature may be a temperature of approximately 40.0° f.

An inverter 26 is included that has an input 23 and an output 25. The input 23 is electrically coupled to an alternator 28 of the vehicle 16 such that the inverter 26 receives voltage from the alternator 28 when the vehicle 16 is running. The inverter 26 may be an electronic inverter for changing DC voltage into AC voltage.

A heater battery 30 is provided and the heater battery 30 is coupled to the vehicle 16. The heater battery 30 is independent from an ignition battery of the vehicle 16. The heater battery 30 is electrically coupled to the output 25 of the inverter 26 such that the alternator 28 charges the heater battery 30 when the vehicle 16 is running. The heater battery 30 may be a battery that has a voltage capacity of at least 40.0 volts. Additionally, the heater battery 30 may be located at a position in the vehicle 16 that is sequestered from occupants of the vehicle 16.

A transformer 32 is included that is coupled to the vehicle 16 and the transformer 32 has an input 34 and an output 36. The input 34 of the transformer 32 is electrically coupled to the heater battery 30 to increase the voltage of the heater battery 30. Additionally, the output 36 of the transformer 32 is electrically coupled to the blower 12 and the heater 20. The transformer 32 may be a solid state, step-up transformer that has an output voltage of approximately 120.0 volts.

A solar panel 38 is provided and the solar panel 38 is coupled to an exterior of the vehicle 16. In this way the solar panel 38 is exposed to sunlight for converting the sunlight into electrical current. The solar panel 38 is electrically coupled to the heater battery 30 for charging the heater battery 30 when the vehicle 16 is not running. The solar panel 38 may be positioned on a roof of the vehicle 16 or other strategic location that does not impede normal use of the vehicle 16.

In use, the heater 20 and the blower 12 are both turned on with the power button 22 in the vehicle 16. Thus, the interior of the vehicle 16 is heated during winter months thereby inhibiting frost from forming on the vehicle's windows. In this way a driver of the vehicle 16 does not have to scrape the frost from the windows or allow the vehicle 16 to warm up before driving the vehicle 16. The solar panel 38 charges the heater battery 30 when the vehicle 16 is not running and the alternator 28 of the vehicle 16 charges the heater battery 30 when the vehicle 16 is running. The heater battery 30 facilitates the blower 12 and the heater 20 to operate without depleting the vehicle's ignition battery.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle defrosting assembly being configured to heat an interior of a vehicle while the vehicle is parked, said assembly comprising:
a blower being positioned in a vehicle, said blower circulating air within a cab when said blower is turned on, said blower being in fluid communication with a defrost duct of the vehicle's air conditioning system;
a heater being integrated into said blower, said heater being in thermal communication with said blower, said heater heating the air circulated by said blower when said heater is turned on wherein said heater is configured to heat the cab of the vehicle thereby inhibiting the formation of frost on the vehicle's windows;
a heater battery being coupled to the vehicle, said heater battery being independent from an ignition battery of the vehicle, each of said blower and said heater being in electrical communication with said heater battery; and
a solar panel being coupled to an exterior of the vehicle wherein said solar panel is configured to be exposed to sunlight, said solar panel being electrically coupled to said heater battery for charging said heater battery when the vehicle is not running.

2. The assembly according to claim 1, further comprising a power button being positioned in the cab of the vehicle, said power button being electrically coupled to said blower and said heater, said power button turning each of said blower and said heater on and off.

3. The assembly according to claim 2, further comprising a thermostat being positioned in the cab of the vehicle wherein said thermostat is configured to detect the temperature in the cab, said thermostat being electrically coupled to said heater, said thermostat turning off said heater when said thermostat detects a temperature that exceeds a pre-determined trigger temperature.

4. The assembly according to claim 3, further comprising an inverter having an input and an output, said input being electrically coupled to an alternator of the vehicle such that said inverter receives voltage from the alternator when the vehicle is running, said heater battery being electrically coupled to said output of said inverter such that the alternative charges said heater battery when the vehicle is running.

5. The assembly according to claim 1, further comprising a transformer being coupled to the vehicle, said transformer having an input and an output, said input being electrically coupled to said heater battery wherein said transformer is configured to increase the voltage of said heater battery, said output being electrically coupled to said blower and said heater.

6. A vehicle defrosting assembly being configured to heat an interior of a vehicle while the vehicle is parked, said assembly comprising:
a blower being positioned in a vehicle, said blower circulating air within a cab when said blower is turned on, said blower being in fluid communication with a defrost duct of the vehicle's air conditioning system;
a heater being integrated into said blower, said heater being in thermal communication with said blower, said heater heating the air circulated by said blower when said heater is turned on wherein said heater is configured to heat the cab of the vehicle thereby inhibiting the formation of frost on the vehicle's windows;
a power button being positioned in the cab of the vehicle, said power button being electrically coupled to said blower and said heater, said power button turning each of said blower and said heater on and off;
a thermostat being positioned in the cab of the vehicle wherein said thermostat is configured to detect the temperature in the cab, said thermostat being electrically coupled to said heater, said thermostat turning off said heater when said thermostat detects a temperature that exceeds a pre-determined trigger temperature;
an inverter having an input and an output, said input being electrically coupled to an alternator of the vehicle such that said inverter receives voltage from the alternator when the vehicle is running;
a heater battery being coupled to the vehicle, said heater battery being independent from an ignition battery of the vehicle, said heater battery being electrically coupled to said output of said inverter such that the alternative charges said heater battery when the vehicle is running;
a transformer being coupled to the vehicle, said transformer having an input and an output, said input being electrically coupled to said heater battery wherein said transformer is configured to increase the voltage of said heater battery, said output being electrically coupled to said blower and said heater; and
a solar panel being coupled to an exterior of the vehicle wherein said solar panel is configured to be exposed to sunlight, said solar panel being electrically coupled to said heater battery for charging said heater battery when the vehicle is not running.
